(19) United States
(12) Patent Application Publication
(10) Pub. No.: US 2021/0277795 A1
(43) Pub. Date: Sep. 9, 2021

(54) COLLECTION SYSTEM FOR A GAS TURBINE ENGINE WASH ASSEMBLY

(71) Applicant: General Electric Company, Schenectady, NY (US)

(72) Inventor: Peng Wang, Shanghai (CN)

(21) Appl. No.: 16/338,871

(22) PCT Filed: Oct. 4, 2016
(86) PCT No.: PCT/CN2016/101426

§ 371 Date: Apr. 2, 2019

(51) Int. Cl. F01D 25/00; B08B 9/00; B08B 17/02; B08B 5/04

(52) U.S. Cl. CPC F01D 25/002; B08B 9/00; B08B 2215/00; B08B 5/04; B08B 17/025

(57) ABSTRACT

A wastewater collection system of a water wash system includes a collection duct configured to attach to a gas turbine engine for receiving a mixture of air and wash liquid from the gas turbine engine during washing. The wastewater collection system additionally includes a separation assembly, the separation assembly including a shaft, one or more impellers mounted to the shaft, and a casing. The casing at least partially encloses the shaft and encloses the one or more impellers. The casing defines an inlet for fluidly connecting with the collection duct, an air outlet, and a liquid outlet. The air outlet is disposed opposite the one or more impellers from the inlet and the liquid outlet.

### FIELD OF THE INVENTION

The present subject matter relates generally to an air and waste wash fluid collection system gas turbine engine wash assembly.

### BACKGROUND OF THE INVENTION

Typical aircraft propulsion systems include one or more gas turbine engines. For certain propulsion systems, the gas turbine engines generally include a fan and a core arranged in flow communication with one another. Additionally, the core of the gas turbine engine general includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

During operation, a substantial amount of air is ingested by such gas turbine engines. However, such air may contain foreign particles. A majority of the foreign particles will follow a gas path through the engine and exit with the exhaust gases. However, at least certain of these particles may stick to certain components within the gas turbine engine's gas path, potentially changing aerodynamic properties of the engine and reducing engine performance.

In order to remove such foreign particles from within the gas path of the gas turbine engine, water or other liquids may be directed towards an inlet of the gas turbine engine, while the core engine is cranked using, e.g., a starter motor. Such movement may enhance the wash results by mechanical engagement between the water and components. Additionally, such rotation may also urge the water through the engine and out the exhaust section.

However, such operations typically spray wastewater in a relatively large contamination area, making it infeasible for such wash operations at, e.g., certain airports, or during certain times. Accordingly, a system for reducing the contamination of such wastewater would be useful.

### BRIEF DESCRIPTION OF THE INVENTION

Aspects and advantages of the invention will be set forth in part in the following description, or may be obvious from the description, or may be learned through practice of the invention.

In one exemplary embodiment of the present disclosure, a waste water collection system of a water wash system for a gas turbine engine is provided. The collection system includes a collection duct configured to attach to the gas turbine engine for receiving a mixture of air and wash liquid from the gas turbine engine during washing. The collection system additionally includes a separation assembly. The separation assembly includes a shaft, one or more impellers mounted to the shaft, and a casing. The casing at least partially encloses the shaft and encloses the one or more impellers. The casing defines an inlet for fluidly connecting with the collection duct to receive a mixture of air and wash liquid, an air outlet, and a liquid outlet. The air outlet is disposed opposite the one or more impellers from the inlet and the liquid outlet.

In another exemplary embodiment of the present disclosure, a liquid and air separation assembly for a waste water collection system of a water wash system is provided. The waste water collection system includes a collection duct for attachment to a gas turbine engine for receiving a mixture of air and wash liquid from the gas turbine engine during washing. The separation assembly includes a shaft, one or more impellers mounted to the shaft, and a casing. The casing at least partially encloses the shaft and encloses the one or more impellers. The casing defines an inlet for fluidly connecting with the collection duct to receive a mixture of air and wash liquid, an air outlet, and a liquid outlet. The air outlet is disposed opposite the one or more impellers from the inlet and the liquid outlet.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic, cross-sectional view of a gas turbine engine in accordance with an exemplary aspect of the present disclosure, operable with a wash system in accordance with an exemplary embodiment of the present disclosure.

FIG. 2 is a schematic view of an air and waste wash fluid collection system for a gas turbine engine in accordance with an exemplary embodiment of the present disclosure.

FIG. 3 is a side, cross-sectional view of an air and waste wash fluid separation assembly in accordance with an exemplary embodiment of the present disclosure for utilization with the exemplary collection system of FIG. 2.

FIG. 4 is a perspective view of the exemplary air and waste wash fluid separation assembly of FIG. 3.

FIG. 5 is a side, cross-sectional view of an air and waste wash fluid separation assembly in accordance with another exemplary embodiment of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “forward” and “aft” refer to relative positions within a gas turbine engine, with forward referring to a position closer to an engine inlet and aft referring to a position closer to an engine nozzle or exhaust. The terms “upstream” and “downstream” refer to the relative direction with respect to fluid flow in a fluid pathway. For example, “upstream” refers to the direction from which the fluid flows, and “downstream” refers to the direction to which the fluid flows.

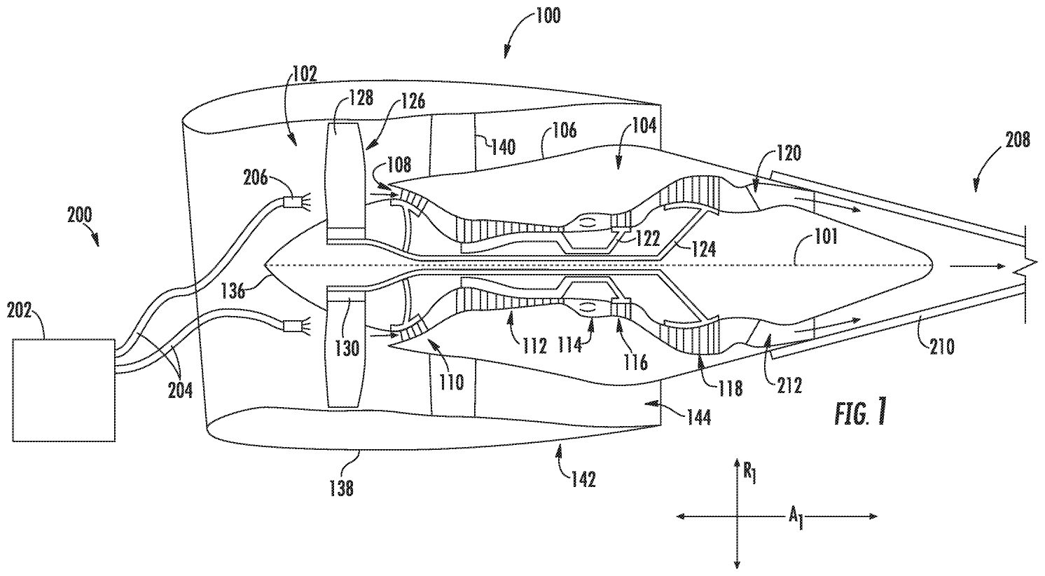

Referring now to the drawings, wherein identical numerals indicate the same elements throughout the figures, FIG. 1 provides a schematic cross-sectional view of a propulsion engine is may be utilized with one or more exemplary aspects of the present disclosure. In certain exemplary embodiments, the propulsion engine may be configured a turbofan jet engine 100, herein referred to as “turbofan 100.” As shown in FIG. 1, the turbofan 100 defines an axial direction A1 (extending parallel to a longitudinal centerline 101 provided for reference), a radial direction R1, and a circumferential direction C1 (extending about the axial direction A1; not shown). As will be appreciated, however, in other embodiments of the present disclosure, the gas turbine engine may be configured in any other suitable manner. For example, aspects of the present disclosure may instead be utilized with any other turbofan engine, turbojet engine, turboprop engine, a turboshaft engine, etc.

In general, the turbofan 100 includes a fan section 102 and a core turbine engine 104 disposed downstream from the fan section 102. The exemplary core turbine engine 104 depicted generally includes a substantially tubular outer casing 106 that defines an annular inlet 108. The outer casing 106 encases, in serial flow relationship, a compressor section including a second, booster or low pressure (LP) compressor 110 and a first, high pressure (HP) compressor 112; a combustion section 114; a turbine section including a first, high pressure (HP) turbine 116 and a second, low pressure (LP) turbine 118; and a jet exhaust nozzle section 120. The compressor section, combustion section 114, and turbine section together define a core air flowpath 121 extending from the annular inlet 108 through the LP compressor 110, HP compressor 112, combustion section 114, HP turbine section 116, LP turbine section 118 and jet nozzle exhaust section 120. A first, high pressure (HP) shaft or spool 122 drivingly connects the HP turbine 116 to the HP compressor 112. A second, low pressure (LP) shaft or spool 124 drivingly connects the LP turbine 118 to the LP compressor 110.

For the embodiment depicted, the fan section 102 includes a fan 126 having a plurality of fan blades 128 coupled to a disk 130 in a spaced apart manner. As depicted, the fan blades 128 extend outwardly from disk 130 generally along the radial direction R1. In certain exemplary aspects, the fan 126 may be a variable pitch fan, such that each of the plurality of fan blades 128 are rotatable relative to the disk about a pitch axis, by virtue of the plurality of fan blades being operatively coupled to an actuation member.

Referring still to the exemplary embodiment of FIG. 1, the disk 130 is covered by rotatable front hub 136 aerodynamically contoured to promote an airflow through the plurality of fan blades 128. Additionally, the exemplary fan section 102 includes an annular fan casing or outer nacelle 138 that circumferentially surrounds the fan 126 and/or at least a portion of the core turbine engine 104. The nacelle 138 is supported relative to the core turbine engine 104 by a plurality of circumferentially-spaced outlet guide vanes 140. A downstream section 142 of the nacelle 138 extends over an outer portion of the core turbine engine 104 so as to define a bypass airflow passage 144 therebetween.

Referring still to FIG. 1, the fan blades 128, disk 130, and front hub 136 are together rotatable about the longitudinal axis 101 directly by the LP spool 124. Accordingly, for the embodiment depicted, the turbofan engine 100 may be referred to as a “direct drive” turbofan engine. However, in other embodiments, the turbofan engine 100 may additionally include a reduction gearbox for driving the fan 126 at a reduced rotational speed relative to the LP spool 124.

Moreover, as is depicted, the exemplary turbofan engine 100 is being cleaned by a gas turbine engine water wash system 200. The water wash system 200 generally includes a rinsing module 202 having one or more lines 204 and nozzles 206 configured to direct a wash fluid through the fan 126 and into the core turbine engine 104. Notably, in other embodiments, some or all of the fan 126 may be removed during such processes. For example, in certain embodiments, the plurality of fan blades 128 may be removed to enable the washing operations. Additionally, in other operations, the wash lines 124 may extend through, e.g., the bypass passage 144 to spray directly into the core turbine engine 104.

The wash fluid flows into the core turbine engine 104 to rinse, e.g. the various compressor blades and nozzles within the compressor section, a combustion chamber of the combustion section 114, and the various turbine blades and nozzles within the turbine section. After having rinsed one or more the above components, the wash fluid exits through the nozzle exhaust section 120. The wash fluid at this stage may generally be referred to as “waste water”. Additionally, it should be appreciated, that the terms “wash liquid” and “wash water” may generally be used interchangeably to refer to any suitable liquid and/or combination of liquid, detergent, or fluid compound that may be utilized to clean the various components of the turbofan engine.

As will be described in greater detail below, the gas turbine engine water wash system 200 further includes a waste water collection system 208 for capturing wash liquid and a liquid-air mixture exiting nozzle exhaust section 120 of the turbofan engine 100. The liquid-air mixture may generally include a combination of waste water and ambient air ingested by the turbofan engine 100 during washing operations. As will be appreciated, during washing operations, wash liquid may be sprayed into the core turbine engine 104, and the core turbine engine 104 may be rotated by, e.g., a starter motor (not shown), such that the core turbine engine 104 ingests ambient air through the inlet 108 and exhausts such air through the exhaust section 120 along with any waste water flowing therethrough.

Referring still to the embodiment depicted in FIG. 1, the waste water collection system 208 includes a collection duct 210 configured to attach to the turbofan engine 100 for receiving the mixture of air and waste water/wash liquid from the core turbine engine 104 of the turbofan engine 100 during washing operations. More specifically, for the embodiment depicted, the collection duct 210 includes an inlet 212 attachable to an outer surface of the outer casing 106 of the core turbine engine 104, such that the collection duct 210 captures substantially all of the mixture of air and wash liquid from the core turbine engine 104 during washing.

It should be appreciated, however, that in other embodiments the present disclosure, the water wash system 200 may be configured in any other suitable manner to include any other components capable of providing a wash liquid, or other wash fluid, to a gas turbine engine for cleaning the gas turbine engine. It should also be appreciated that such a water wash system 200 may further be operable with any other suitable gas turbine engine (e.g., any suitable turbofan engine, turboprop engine, turboshaft engine, turbojet engine, etc.).

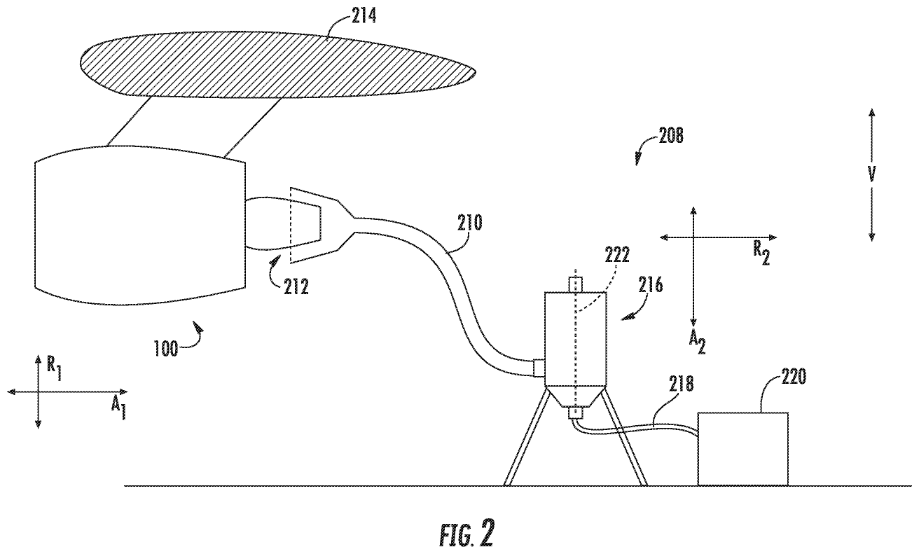

Referring now to FIG. 2, a schematic view is provided of a waste water collection system 208 in accordance with an exemplary embodiment of the present disclosure. In at least certain exemplary aspects, the waste water collection system 208 of FIG. 2 may be configured in substantially the same manner as the exemplary waste water collection system 208 described above with reference to FIG. 1. Accordingly, the exemplary waste water collection system 208 generally includes a collection duct 210 configured to attach to a gas turbine engine for receiving a mixture of air and wash fluid, or a wash liquid, from the gas turbine engine during washing operations. Notably, the gas turbine engine depicted in FIG. 2 may, in certain exemplary embodiments be configured similarly to the exemplary turbofan engine 100 described above with reference FIG. 1. Additionally, as is depicted, the exemplary gas turbine engine of FIG. 2 is attached beneath a wing 214 of an aircraft (not shown).

Additionally, the exemplary waste water collection system 208 further includes a separation assembly 216 fluidly connected to the collection duct 210, and a waste water duct 218 extending from the separation assembly 216 to a wastewater container 220. Accordingly, the wastewater duct 218 is fluidly connected to the separation assembly 216 and the waste water container 220. The separation assembly 216 is configured to receive the mixture of air and wash fluid from the collection duct 210, extract liquid and moisture within the airflow, and exhaust the airflow while collecting and containing the waste water. As will be describe in greater detail below, the separation assembly 216 generally defines an axial direction A2 extending along a length thereof. For the embodiment depicted, the axial direction A2 substantially aligns with a vertical direction V.

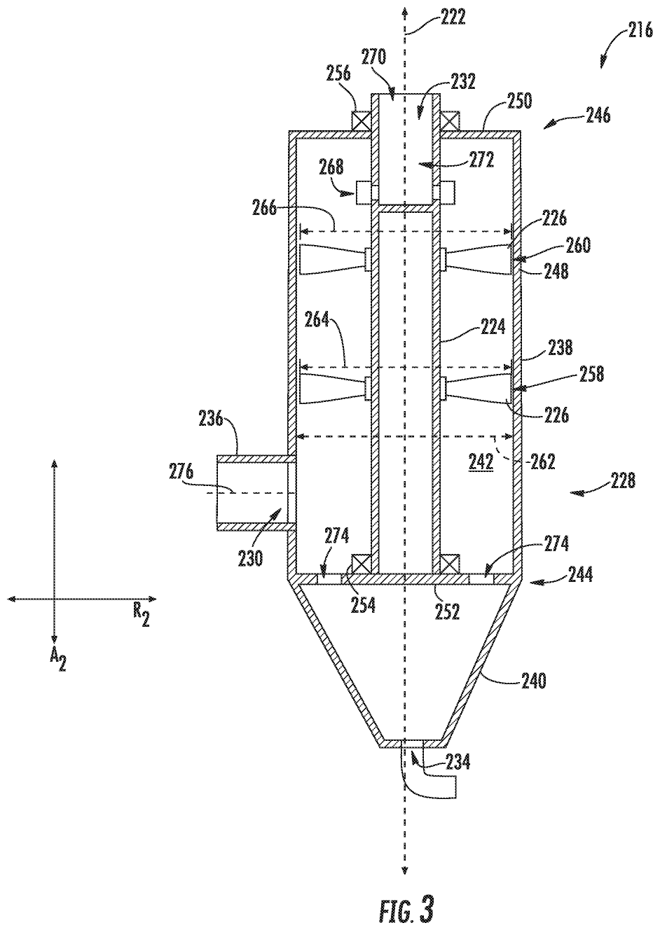

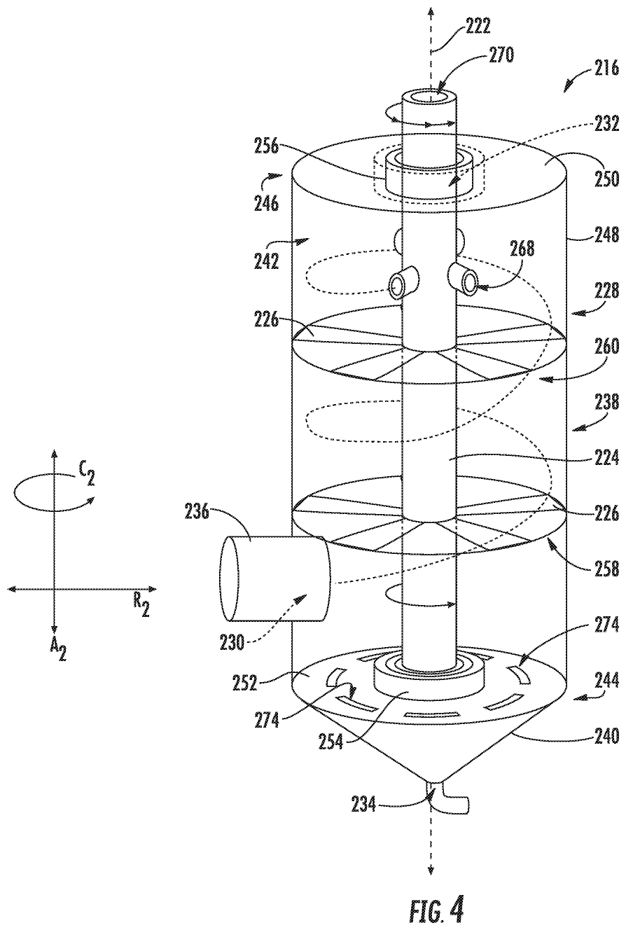

Referring now to FIGS. 3 and 4, close-up views of the exemplary separation assembly 216 of FIG. 2 are provided. Specifically, FIG. 3 provides a side, cross-sectional view of the exemplary separation assembly 216, and FIG. 4 provides a side, perspective view of the separation assembly 216, with a portion of a casing 228 removed for clarity. As is depicted, the separation assembly 216 generally defines the axial direction A2 (and a central axis 222 extending along the axial direction A2, for reference), a radial direction R2, and a circumferential direction C2 (see FIG. 4).

As is depicted, the separation assembly 216 generally includes a shaft 224, one or more impellers 226 mounted to the shaft 224, and a casing 228 at least partially enclosing the shaft 224 and enclosing the one or more impellers 226. The casing 228 generally defines an inlet 230, an air outlet 232 and a liquid outlet 234. More specifically, the casing 228 comprises an inlet flange 236 defining the inlet 230, with the inlet 230 configured for fluidly connecting with a collection duct 210 to receive a mixture of air and wash liquid (see FIG. 2). As will be described in greater detail below, the air outlet 232 is disposed opposite the one or more impellers 226 from the inlet 230 and liquid outlet 234, such that the one or more impellers 226 are driven by an airflow from the inlet 230 to the air outlet 232.

The casing 228 generally includes a body 238 and a liquid collection section 240. The body 238 defines an interior chamber 242 and a substantially cylindrical shape. Additionally, the body 238 extends between a first end 244 and a second end 246 generally along the axial direction A2. The shaft 224 also extends substantially along the axial direction A2 at least partially within the interior chamber 242 of the body 238 and rotates about the axial direction A2. The shaft 224 is mounted to the casing 228, and more particularly, for the embodiment depicted, is mounted to the body 238 of the casing 228. For example, the body 238 generally includes a cylindrical outer wall 248, a bottom plate 252 at the first end 244, and a top plate 250 at the second end 246. The separation assembly 216 further includes a first bearing 254 and a second bearing 256. The first bearing 254 rotatably attaches the shaft 224 to the casing 228 proximate the first end 244 of the body 238 and the second bearing 256 rotatably attaches the shaft 224 to the casing 228 proximate the second end 246 of the body 238. More specifically, for the embodiment depicted, the first bearing 254 rotatably attaches the shaft 224 to the bottom plate 252 of the body 238 and, similarly, the second bearing 256 rotatably attaches the shaft 224 to the top plate 250 of the body 238.

As stated, the shaft 224 is rotatable about the axial direction A2. Additionally, the one or more impellers 226 are attached to the shaft 224 for rotating the shaft 224. For the embodiment depicted, the one or more impellers 226 includes a plurality of impellers defining one or more stages. Specifically, for the embodiment depicted, the plurality of impellers 226 includes a plurality of first stage impellers 258 and a plurality of second stage impellers 260. The plurality of first stage impellers 258 are spaced from the plurality of second stage impellers 260 along the axial direction A2 of the separation assembly 216.

Referring particularly to FIG. 3, the body 238 of the casing 228 defines an inner diameter 262. Specifically, for the embodiment depicted, the inner diameter 262 of the body 238 of the casing 228 is defined by the cylindrical outer wall 248 of the body 238 of the casing 228. Additionally, the plurality of first stage impellers 258 collectively define an effective first stage impeller diameter 264 and the plurality of second stage impellers 260 collectively define an effective second stage impeller diameter 266. Notably, as used herein, the effective impeller diameters refer to twice a distance from the central axis 222 of the separation assembly 216 to an outer tip of the impeller along the radial direction R2. For the embodiment depicted, the plurality of first and second stage impellers 258, 260 each define a relatively tight clearance with the body 238 of the casing 228. Specifically, for the embodiment depicted, the inner diameter 262 of the body 238 is less than about 20% greater than the effective first stage impeller diameter 264 and the effective second stage impeller diameter 266. For example, in certain exemplary embodiments, the inner diameter 262 of the body 238 may be less than about 15% greater than the effective first and second stage impeller diameters 264, 266, such as less than about 10% greater than the effective first and second stage impeller diameters 264, 266. As discussed below, such a configuration may assist with ensuring an airflow from the inlet 230 to the air outlet 232 generates a rotation of the impellers 226 and shaft 224.

Additionally, referring to the air outlet 232, for the embodiment depicted the shaft 224 defines a first opening 268 and a second opening 270, with an airflow passage 272 extending between the first and second openings 268, 270. Additionally, the airflow passage 272 extends through the air outlet 232 of the casing 228. Notably, the first opening 268 is positioned within the interior chamber 242 of the body 238 of the casing 228 and disposed opposite the one or more impellers 226 from the inlet 230 and the liquid outlet 234 defined by the casing 228. Additionally, the shaft 224 includes a plurality of first openings 268 spaced along the circumferential direction C2.

Accordingly, during operation of the separation assembly 216, a mixture of air and wash liquid may be received within the interior chamber 242 of the body 238 of the casing 228 through the inlet 230 defined by the casing 228. The mixture may define a relatively high pressure relative to an ambient pressure. Accordingly, the mixture, including pressurized and moisture laden air, may flow from the inlet 230, across the one or more impellers 226, towards the air outlet 232 defined by the casing 228. Such a flow across the one or more impellers 226 may rotate the one or more impellers 226, i.e., driving a rotation of the impellers 226 and shaft 224. As the impellers 226 and shaft 224 begin to rotate at a relatively high angular speed, moisture within the mixture may impinge upon the impellers 226, and a centrifugal force acting thereon (due to the rotation of impellers 226) may cause such moisture to collect along an inner surface of the outer wall 248 of the body 238 of the casing 228. The moisture may then fall towards the first end 244 of the body 238, e.g., due to a natural gravitational force. As is depicted, the bottom plate 252 of the body 238 of the casing 228 includes a plurality of openings 274, which may allow for the collected liquid to pass therethrough and into the collection section 240 of the casing 228. The collected liquid (i.e., waste water) may flow through the liquid outlet 234, which during operation may be in fluid communication with the waste water duct 218 (see FIG. 2).

A waste water collection system including a separation assembly in accordance with one or more embodiments of the present disclosure may allow for operation of a water wash system without an undesirable spraying of waste water. Specifically, utilizing a collection system having a separation assembly in accordance with one more embodiments of the present disclosure may allow for collection of the air and waste water mixture exiting a gas turbine engine during washing, and effectively separating the air therefrom to collect substantially all of such waste water. Notably, such a system additionally may operate without use of external power sources.

It should be appreciated, however, that in other embodiments of the present disclosure, the waste water collection system 208 and separation assembly 216 may have any other suitable configuration. For example, in other embodiments, the casing 228 of the separation assembly 216 may have any other suitable shape or configuration; the separation assembly 216 may include any other suitable number of stages of impellers 226, or number of impellers 226 in general; the separation assembly 216 may be oriented in any other suitable direction; the shaft 224 may be mounted in any other suitable manner within the casing 228; etc.

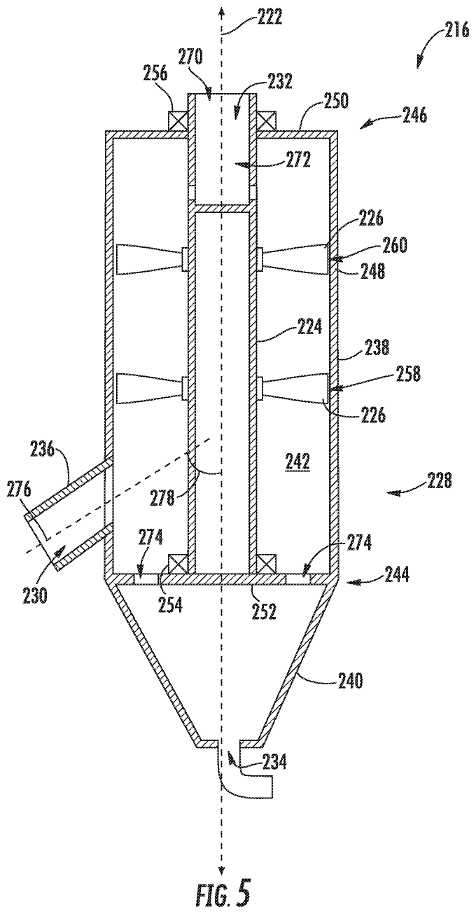

For example, referring now to FIG. 5, a separation assembly 216 in accordance with another exemplary embodiment of the present disclosure is depicted. The exemplary separation assembly 216 of FIG. 5 may be configured in substantially the same manner as exemplary separation assembly 216 described above with reference to FIGS. 2 through 4. Accordingly, the same or similar numbers refer to the same or similar part.

As is depicted, the separation assembly 216 generally includes a shaft 224, one or more impellers 226, and a casing 228. The casing 228 defines an inlet 230 fluidly connecting with a collection duct 210, an air outlet 232, and a liquid outlet 234. Additionally, the air outlet 232 is disposed opposite the one or more impellers 226 from the inlet 230 and the liquid outlet 234.

Moreover, for the embodiment depicted, the inlet 230 is defined by an inlet flange 236 of the casing 228. However, for the embodiment depicted, the inlet flange 236 is oriented towards the one or more impellers 226. More specifically, the inlet flange 236 defines a centerline 276, with the centerline 276 defining an acute angle 278 with the central axis 222 of the separation assembly 216. Further, for the embodiment depicted, the air outlet 232 of the casing 228 is defined by a top plate 250 of the body 238 of the casing 228. Accordingly, the shaft 224 does not define an airflow passage (see airflow passage 272 of FIGS. 3 and 4) extending through the air outlet 232 of the casing 228. Additionally, as is depicted, the air outlet 232 comprises a plurality of air outlets 232 defined by the top plate 250 of the body 238 of the casing 228. Notably, however, in other embodiments, the air outlet 232 may instead be defined at any other suitable location.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

### COMPONENT LIST

| Reference | |
|---|---|
| Character | Component |
| 100 | Turbofan Jet Engine |
| 101 | Longitudinal or Axial Centerline |
| 102 | Fan Section |
| 104 | Core Turbine Engine |
| 106 | Outer Casing |
| 108 | Inlet |
| 110 | Low Pressure Compressor |
| 112 | High Pressure Compressor |
| 114 | Combustion Section |
| 116 | High Pressure Turbine |
| 118 | Low Pressure Turbine |
| 120 | Jet Exhaust Section |
| 122 | High Pressure Shaft/Spool |
| 124 | Low Pressure Shaft/Spool |
| 126 | Fan |
| 128 | Blades |
| 130 | Disc |
| 136 | Front hub |
| 138 | Fan Casing or Nacelle |
| 140 | Outlet Guide Vane |
| 142 | Downstream Section |
| 144 | Bypass Airflow Passage |
| 200 | Water wash system |
| 202 | Rinsing module |
| 204 | Supply lines |
| 206 | Nozzles |
| 208 | Collection system |
| 210 | Collection duct |
| 212 | Inlet to collection duct |
| 214 | Wing |
| 216 | Separation assembly |
| 218 | Wastewater duct |
| 220 | Wastewater container |
| 222 | Central axis |
| 224 | Shaft |
| 226 | Impellers |
| 228 | Casing |
| 230 | Inlet |
| 232 | Air outlet |
| 234 | Liquid outlet |
| 236 | Inlet flange |
| 238 | Body |
| 240 | Liquid collection section |
| 242 | Interior chamber |
| 244 | 1^{st} end a body |
| 246 | 2^{nd} end of body |
| 248 | Outer wall |
| 250 | Top plate |
| 252 | Bottom plate |
| 254 | 1^{st} bearing |
| 256 | Secondary |
| 258 | 1^{st} stage impellers |
| 260 | 2^{nd} stage impellers |
| 262 | Inner diameter of casing |
| 264 | 1^{st} stage impeller diameter |
| 266 | 2^{nd} stage impeller diameter |
| 268 | 1^{st} opening |
| 270 | 2^{nd} opening |
| 272 | Airflow passage |
| 274 | Openings and bottom plate 252 |
| 276 | Centerline of the inlet flange |
| 278 | Angle with Central axis |

What is claimed is:

1. A waste water collection system of a water wash system for a gas turbine engine, the collection system comprising:
a collection duct configured to attach to the gas turbine engine for receiving a mixture of air and wash liquid from the gas turbine engine during washing; and
a separation assembly comprising
a shaft;
one or more impellers mounted to the shaft; and
a casing at least partially enclosing the shaft and enclosing the one or more impellers, the casing defining an inlet for fluidly connecting with the collection duct to receive a mixture of air and wash liquid, an air outlet, and a liquid outlet, the air outlet disposed opposite the one or more impellers from the inlet and the liquid outlet.

2. The collection system of claim 1, wherein the separation assembly defines an axial direction, and wherein the shaft extends along and rotates about the axial direction.

3. The collection system of claim 2, wherein the axial direction substantially aligns with a vertical direction.

4. The collection system of claim 2, wherein the casing comprises a body defining a substantially cylindrical shape, wherein the body defines an inner diameter, wherein the one or more impellers define an effective impeller diameter, and wherein the inner diameter the body is less than about 20% greater than the effective impeller diameter.

5. The collection system of claim 2, wherein the one or more impellers includes a plurality of first stage impellers and a plurality of second stage impellers, wherein the plurality of first stage impellers are spaced from the plurality of second stage impellers along the axial direction.

6. The collection system of claim 1, wherein the shaft defines an airflow passage extending between a first opening and a second opening and through the air outlet of the casing, and wherein the first opening is disposed opposite the one or more impellers from the inlet and the liquid outlet.

7. The collection system of claim 1, wherein the casing comprises a body defining a substantially cylindrical shape extending between a first end and a second end, wherein the separation assembly further comprises a first bearing and a second bearing, wherein the first bearing rotatably attaches the shaft to the casing proximate the first end of the body, and wherein the second bearing rotatably attaches the shaft to the casing proximate the second end of the body.

8. The collection system of claim 1, wherein the shaft and the one or more impellers are driven by an airflow from the inlet defined by the casing to the air outlet defined by the casing.

9. The collection system of claim 1, wherein the casing of the separation assembly comprises an inlet flange defining the inlet, and wherein the inlet flange is oriented towards the one or more impellers.

10. The collection system of claim 1, wherein the casing of the separation assembly comprises an inlet flange defining the inlet, wherein the separation assembly defines an axial direction, and wherein the inlet flange is oriented substantially perpendicular to the axial direction.

11. The collection system of claim 1, further comprising:
a waste water duct in fluid communication with the liquid outlet defined by the casing.

12. A liquid and air separation assembly for a waste water collection system of a water wash system, the waste water collection system including a collection duct for attachment to a gas turbine engine for receiving a mixture of air and wash liquid from the gas turbine engine during washing, the separation assembly comprising:
a shaft;
one or more impellers mounted to the shaft; and
a casing at least partially enclosing the shaft and enclosing the one or more impellers, the casing defining an inlet for fluidly connecting with the collection duct to receive a mixture of air and wash liquid, an air outlet, and a liquid outlet, the air outlet disposed opposite the one or more impellers from the inlet and the liquid outlet.

13. The separation assembly of claim 12, wherein the separation assembly defines an axial direction, and wherein the shaft extends along and rotates about the axial direction.

14. The separation assembly of claim 13, wherein the axial direction substantially aligns with a vertical direction.

15. The separation assembly of claim 13, wherein the casing comprises a body defining a substantially cylindrical shape, wherein the body defines an inner diameter, wherein the one or more impellers define an effective impeller diameter, and wherein the inner diameter the body is less than about 20% greater than the effective impeller diameter.

16. The separation assembly of claim 13, wherein the one or more impellers includes a plurality of first stage impellers and a plurality of second stage impellers, wherein the plurality of first stage impellers are spaced from the plurality of second stage impellers along the axial direction.

17. The separation assembly of claim 12, wherein the shaft defines an airflow passage extending between a first opening and a second opening and through the air outlet of the casing, and wherein the first opening is disposed opposite the one or more impellers from the inlet and the liquid outlet.

18. The separation assembly of claim 12, wherein the casing comprises a body defining a substantially cylindrical shape extending between a first end and a second end, wherein the separation assembly further comprises a first bearing and a second bearing, wherein the first bearing rotatably attaches the shaft to the casing proximate the first end of the body, and wherein the second bearing rotatably attaches the shaft to the casing proximate the second end of the body.

19. The separation assembly of claim 12, wherein the shaft and the one or more impellers are driven by an airflow from the inlet defined by the casing to the air outlet defined by the casing.

20. The separation assembly of claim 12, wherein the casing of the separation assembly comprises an inlet flange defining the inlet, and wherein the inlet flange is oriented towards the one or more impellers.
